(19) United States
(12) Patent Application Publication
(10) Pub. No.: US 2014/0340393 A1
(43) Pub. Date: Nov. 20, 2014

(54) SYSTEM AND METHOD FOR ERROR CONTROLLABLE REPETITIVE STRUCTURE DISCOVERY BASED COMPRESSION

(71) Applicants: Kangying Cai, Beijing (CN); Wenfei Jiang, Wuhan (CN); Tao Luo, Beijing (CN)

(72) Inventors: Kangying Cai, Beijing (CN); Wenfei Jiang, Wuhan (CN); Tao Luo, Beijing (CN)

(73) Assignee: THOMSON LICENSING, Issy de Moulineaux (FR)

(21) Appl. No.: 14/374,949

(22) PCT Filed: Feb. 3, 2012
(86) PCT No.: PCT/CN2012/070877

§ 371 Date: Jul. 28, 2014

(51) Int. Cl. G06T 9/00

(52) U.S. Cl. CPC G06T 9/001; G06T 2200/04
USPC 345/419

(57) ABSTRACT

A method and an apparatus for 3D model compression are described. Repetitive structures in the 3D model are identified to increase the compression ratio by reducing the redundancy among the instance components. The instance components can be expressed in a “pattern-instance” representation and a decision is made as to whether to compress the “pattern-instance” representation for the 3D model. For those instance components that are determined to be encoded in “pattern-instance” representation, a verification process is employed to examine the decoding error of the instance components. If the decoding error is below a threshold value, the instance components are compressed in the “pattern-instance” representation. Otherwise, a different encoding mode is used to compress the instance components.

### TECHNICAL FIELD

The present invention generally relates to three dimensional (3D) models. More particularly, it relates to compression and transmission of 3D models in a 3D program.

### BACKGROUND OF THE INVENTION

In practical applications, such as 3D games, virtual chatting room, digital museum, and CAD, many 3D models consist of a large number of connected components. These multi-connected 3D models usually contain a non-trivial amount of repetitive structures via various transformations, as shown in FIG. 1. An efficient compression method for this kind of 3D models should be able to explore the repetitive structures and extract the redundancy to achieve a high compression ratio.

Methods to automatically discover the repetitive geometric features in large 3D engineering models have been proposed, such as D. Shikhare, S. Bhakar and S. P. Mudur. Compression of Large 3D Engineering Models using Automatic Discovery of Repeating Geometric Features, 6th International Fall Workshop on Vision, Modeling and Visualization (VMV2001), Nov. 21-23, 2001, Stuttgart, Germany. However, these methods did not provide a complete compression scheme for 3D engineering models. For example, Shikhare et al. did not provide a solution for compressing the necessary transformation information for restoring a connected component. Considering of the large size of connected components a 3D engineering model usually has, the transformation information will also consume a big amount of storage if not compressed.

In PCT application WO2010149492 filed on Jun. 9, 2010, entitled Efficient Compression Scheme for Large 3D Engineering Models, an efficient compression algorithm for multi-connected 3D models by taking advantage of discovering repetitive structures in the input models is disclosed. It first discovers in a 3D model the structures or components repeating in various positions, orientations and scaling factors. Then the repetitive structures/components in the 3D model are organized using “pattern-instance” representation. A pattern is the representative geometry of the corresponding repetitive structure. The instances of a repetitive structure correspond to the components belonging to the repetitive structure and are represented by their transformations, i.e. the positions, orientations and possible scaling factors, with respect to the corresponding pattern and the pattern identification.

To restore the original model from the “pattern-instance” representation, the instance components are calculated by

Inst_Comp=Inst_Transf×Pattern, (1)

where Inst_Transf is the transformation matrix transforming the corresponding pattern to the instance component Inst_Comp. The decoder calculates the transformation matrix Inst_Transf by deriving it from the decoded position, orientation and scaling information, such as

Inst_Transf=Func(Pos_Instra,Ori_Instra,Scal_Instra), (2)

where Pos_Instra, Ori_Instra and Scal_Instra are the decoded position, orientation and scaling factor of the instance component to be restored. Thus the instance components can be restored by

Inst_Comp=Func(Pos_Instra,Ori_Instra,Scal_Instra)×Pattern. (3)

The compression scheme disclosed in WO2010149492 has achieved significant bitrates saving compared to traditional 3D model compression algorithms which do not discover repetitive structures.

The present invention solves the problem of 3D model compression and proposes an algorithm which can discover repetitive structures and further control the decoding error.

### SUMMARY OF THE INVENTION

This invention directs to methods and apparatuses for 3D model compression.

According to an aspect of the present invention, there is provided a method for encoding a 3D model, which comprises the steps of identifying a repetitive structure in said 3D model, encoding said repetitive structure in a repetitive structure encoding mode, and verifying each encoded instance component of said encoded repetitive structure.

According to another aspect of the present invention, there is provided a method for decoding a compressed 3D model, which comprises the steps of decoding patterns from a bitstream of the compressed 3D model; decoding instance component information from the bitstream; and restoring instance components using the decoded patterns and the decoded instance component information.

### BRIEF DESCRIPTION OF THE DRAWINGS

The above features of the present invention will become more apparent by describing in detail exemplary embodiments thereof with reference to the attached drawings in which:

FIG. 1 illustrates 3D models with a large number of connected components and repetitive structures.

FIG. 2 shows a block diagram of a 3D model encoder according to the principles of the current invention.

FIG. 3 shows a block diagram of a repetitive structure encoder according to one embodiment of the present invention.

FIG. 4 shows a block diagram of an instance verification unit according to one embodiment of the present invention.

FIG. 5 shows a block diagram of a 3D model decoder according to the principles of the present invention.

FIGS. 6A and 6B show detailed block diagrams of the PB3DMC codec according to one embodiment of the present invention: FIG. 6A: PB3DMC encoder and FIG. 6B: PB3DMC decoder.

FIGS. 7A and 7B show high-level block diagrams of the PB3DMC codec according to one embodiment of the present invention: FIG. 7A: PB3DMC encoder and FIG. 7B: PB3DMC decoder.

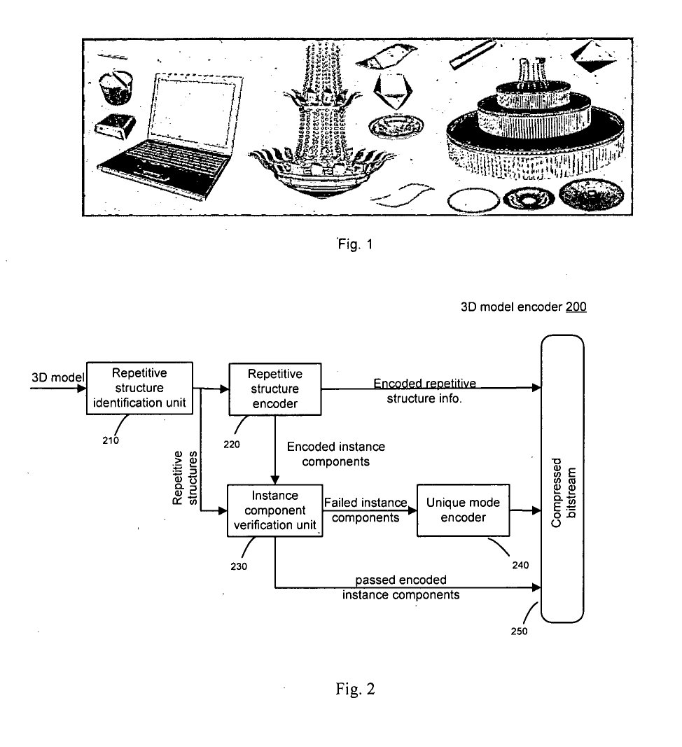

### DETAILED DESCRIPTION

In the present invention, a solution to compress a 3D model is proposed, by discovering repetitive structures and controlling the decoding error.

FIG. 2 shows a block diagram of a 3D model encoder 200 according to the principles of the present invention. The 3D model encoder comprises a repetitive structure identification unit 210, which identifies repetitive structures in the 3D model to be compressed. It also identifies the components that do not belong to any repetitive structures, which are called unique components. In this application, the terms repeating structure or repetitive structure are used interchangeably and both refer to a set of components that repeat in various positions, orientations and scaling factors. These components are referred to as the instance components of the repeating/repetitive structure. The repetitive structure identification unit 210 outputs the identified components of the 3D model including repetitive structures and the instance components thereof. In one embodiment, it also generates a pattern for each identified repetitive structure and instance component information for each instance component, such as a transformation matrix between the instance component and the pattern. As mentioned before, a pattern for a repetitive structure is a representative geometry of the corresponding set of instance components. For those identified repetitive structures, a repetitive structure encoder 220 is used to perform the encoding, which is called a repetitive-structure (RS) mode encoding. The RS mode encoding takes into account the relationship among the instance components within a repetitive structure. The outputs of the repetitive structure encoder 220 are the encoded repetitive structure information representing each repetitive structure, such as encoded patterns in one embodiment, and encoded instance components of the corresponding repetitive structure. As will be disclosed later, a different encoding mode is called a unique encoding mode which does not explore the structural relationship among the components to be encoded. An instance component verification unit 230 further verifies each of the encoded instance components to determine if compressing the instance component in the RS mode is appropriate. One example measurement for the appropriateness is the decoding error of the instance components. That is, the encoding of an instance component is regarded as appropriate if its decoding error is small enough, and vice versa. If the verification unit determines that a RS encoded instance component passes the verification, the encoded instance component is sent to the compressed bitstream; otherwise, it will be re-encoded in a different encoding mode.

In one embodiment, the 3D encoder 200 further comprises a unique mode encoder 240 for re-encoding the instance components output by the instance component verification unit as failing the verification. The unique mode encoder treats each of the components to be encoded as an independent component by individually compressing each component or compressing all such components altogether. An example unique mode encoder is a traditional mesh encoder.

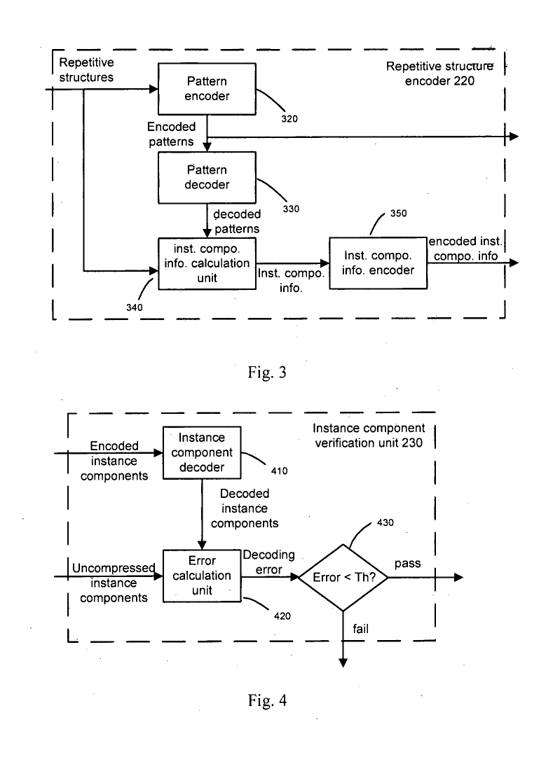

FIG. 3 depicts an embodiment of the repetitive structure (RS) encoder 220. The repetitive structure encoder takes the repetitive structures including the patterns identified in the repetitive structure identification unit as inputs and employs a pattern encoder 320 to encode the patterns. One example of such a pattern encoder is a mesh encoder. In different embodiments, the generated patterns can be encoded separately or encoded together. The encoded patterns are then decoded by a pattern decoder 330. In one embodiment, the pattern decoder comprises a pattern recognizer (not shown) to recognize the decoded patterns to find out, for example, the relationship of the decoded patterns and the original patterns. This is useful in scenarios such as when the pattern encoder and the pattern decoder generates different orders of the patterns and the order of the patterns is relied on when encoding/decoding the 3D models, especially the instance components. The decoded patterns and the instance components in the input repetitive structure are then fed into an instance component information calculation unit 340 to obtain the instance component information for each instance component by comparing it with the corresponding decoded pattern. In a non-limiting example, the instance component information comprises the transformation matrix between the instance component and the corresponding decoded pattern as well as an identification to the decoded pattern. A component information encoder 350 is then employed to encode such instance component information. In a different embodiment, the component information calculation unit 340 is included in the component information encoder 350. The encoded pattern and the encoded instance component information are the outputs of the RS encoder. According to another embodiment, the instance component information, i.e. the transformation matrix in one embodiment, can be calculated by comparing the instance component with the original pattern in the repetitive structure identification unit 210 or in the instance component information calculation unit 340. The transformation matrix generated by such a comparison is then fed into the instance component information encoder 350 for compression.

FIG. 4 shows an embodiment of the instance component verification unit 230. It comprises an instance component decoder 410, an error calculation unit 420 and a determination unit 430. The instance component decoder decodes the encoded instance components to generate the decoded instance components. The error calculation unit compares the decoded instance component with the corresponding uncompressed instance component to calculate a decoding error. Based on the decoding error, the determination unit determines if the encoded component passes the verification. In one implementation, the determination unit determines that the encoded component passes the verification if the calculated decoding error is lower than a threshold; otherwise the encoded component fails the verification. The threshold can be determined by a user input quality parameter. Example values for the quality parameters can be found in the Quality Parameter (QP) table as will be disclosed later in the application.

In a different embodiment, the 3D model encoder 200 further comprises a compression mode determining unit (not shown) after the repetitive structure identification unit for determining whether to compress the entire 3D model in a unique encoding mode, that is, encoding the 3D model without exploring the pattern-instance representation. One example implementation of the unique mode encoding is to use a traditional 3D mesh encoder. One reason for the determining step is to make sure to compress the 3D model in the RS encoding mode when it can result in bit savings. If there are no bit savings, a unique mode encoding is preferred. According to one embodiment of the present invention, the unique mode encoding for the 3D model is chosen if the number of instance components in the repetitive structures are smaller than a threshold. For example, if the instance components include less than a predetermined ratio, e.g. 50%, of the input vertices, the geometry representation of the entire input 3D model is compressed in the unique encoding mode.

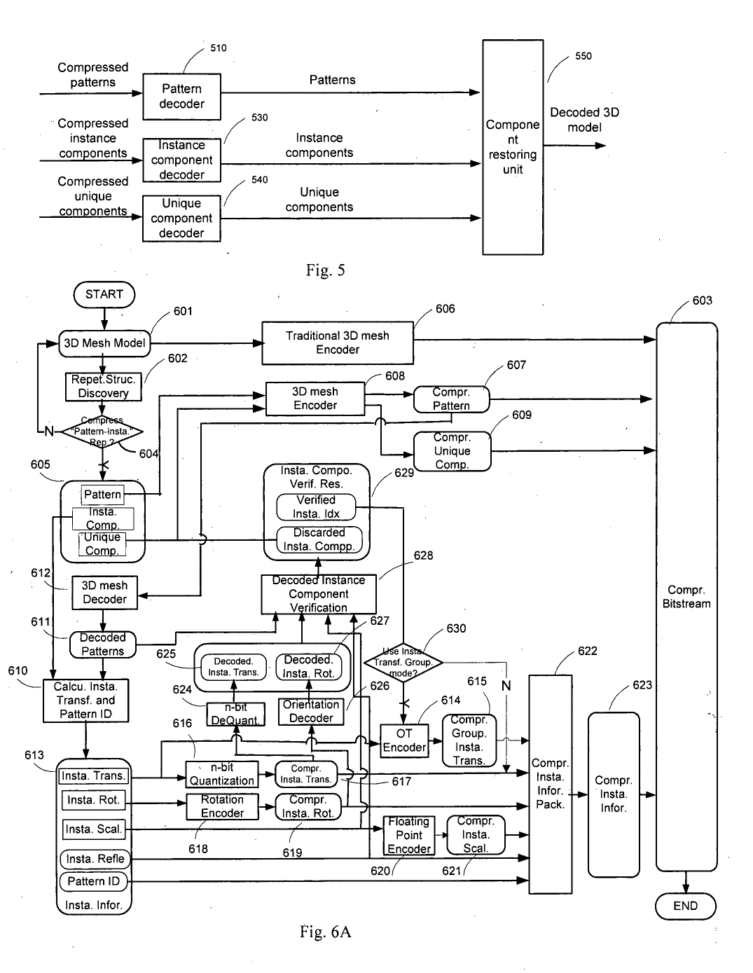

FIG. 5 shows the block diagram of a 3D model decoder 500 according to the principles of the present invention. The 3D model decoder comprises a pattern decoder 510 for decoding patterns from a bitstream of an incoming compressed 3D model, an instance component information decoder 530 for decoding instance component information from the bitstream and a component restoring unit 550 for restoring the instance components from the decoded patterns and the decoded instance component information. In one embodiment, the pattern decoder further comprises a pattern recognizer (not shown) to separate the patterns from the decoded pattern model if the patterns are encoded together as one pattern model.

The decoder further comprises a unique component decoder 540 for decoding unique components in the bitstream if there is any. The decoded unique components are then incorporated with the restored instance components to generate the decoded 3D model in the component restoring unit 550.

The following presents a preferred detailed embodiment of the 3D model compression according to the present invention, which is called Pattern-based 3D Model Compression (PB3DMC) codec. A few highlights on the PB3DMC codec are:
In order to control the decoding error of the entire model precisely, PB3DMC encoder verifies instance components using the decoded patterns and the decoded instance information before outputting the encoded instance components to the compressed bitstream. The instance verification step decodes the encoded instance components and checks their decoding error. Those components with decoding error larger than a user specified threshold will not be compressed as instances. Instead, they will be encoded as unique components which do not belong to any repetitive structure.
In order to get accurate transformation for each instance component, instead of using the instance transformation calculated from the uncompressed pattern, PB3DMC encoder recalculates the instance transformation using decoded patterns before the verification.
PB3DMC encoder encodes the instance transformation matrix directly instead of encoding instance positions, orientations and scaling factors, and PB3DMC decoder employs Eqn. (1) to restore instance components. Thus the decoding error can be significantly reduced.

PB3DMC encoder includes the following main steps:
Discover/identify repetitive structures.
Encode patterns.
Update instance transformations using decoded patterns.
Encode instances.
Verify instances.
Encode unique components, including those components which fail to pass the instance verification test.

PB3DMC decoder includes the following main steps.
Decode patterns.
Decode instances.
Restore instance components.
Decode unique components.
Restore the entire model.

Some of the major steps are explained below:

E.1) Discover Repetitive Structures (602)

In this step, repetitive structures among connected components are identified in the combination of translation, rotation, uniform scaling and reflection transformations. Compared with those schemes which do not consider the reflection transformation, the PB3DMC can discover more repetitive structures and further improve compression ratio. For example, when considering reflection transformations, each of the three eigenvectors found by a PCA analysis of the component is used as the axis for the mirror reflection of the component to examine whether it is similar to other components. An exhaustive search scheme requires 8 comparisons for each component. A more efficient searching scheme is also possible.

The repetitive structure discovery is performed by a pair-wise comparison of connected components. In a preferred embodiment, in order to increase efficiency of the comparison, all components are first clustered by utilizing each component's vertex normal distribution as its feature vector for clustering, as disclosed in PCT application PCT/CN2011/080382 filed on Sep. 29, 2011, entitled “Robust Similarity Comparison of 3D Models,” the teachings of which are herein incorporated by reference in its entirety. Only the components belonging to the same cluster are compared with each other. Two components are aligned first before the comparison. Component alignment involves two steps. First align two components by their positions, orientations and scaling factors. Then they are further aligned using iterated closest points (ICP) algorithm, such as, Rusinkiewicz, S., and Levoy, M. Efficient Variants of the ICP Algorithm, in 3DIM, 145-152, 2001, which includes iterative rotation and translation transformation. Two components are determined to belong to the same repetitive structure if their surface distance is small enough after being aligned with each other. An example method for calculating the surface distance between two components can be found in N. Aspert, D. Santa-Cruz and T. Ebrahimi, MESH: Measuring Error between Surfaces using the Hausdorff distance, in Proceedings of the IEEE International Conference on Multimedia and Expo 2002 (ICME), vol. I, pp. 705-70. The surface distance threshold value can be determined based on a user input Quality Parameter (QP) table, an example of which is shown below:

| | | | | | | | | |
|---|---|---|---|---|---|---|---|---|
| QP | 0 | 1 | 2 | 3 | 4 | 5 | 6 | 7 |
| Distance threshold | FLT_MAX | FLT_MAX | FLT_MAX | FLT_MAX | 0.7 | 0.7 | 0.2 | 0.2 |
| QP | 8 | 9 | 10 | 11 | 12 | 13 | 14 | 15 |
| Distance threshold | 0.05 | 0.05 | 0.013 | 0.013 | 0.001 | 0.001 | 0.001 | 0.001 |
| QP | 16 | 17 | 18 | 19 | 20 | 21 | 22 | 23 |
| Distance threshold | 0.001 | 0.001 | 0.001 | 0.001 | 0.001 | 0.001 | 0.001 | 0.001 |
| QP | 24 | 25 | 26 | 27 | 28 | 29 | 30 | 31 |
| Distance threshold | 0.001 | 0.001 | 0.001 | 0.001 | 0.001 | 0.001 | 0.001 | 0.001 |

where FLT_MAX is the maximum float point number value.

Repetitive structure discovery generates repetitive structures which consist of patterns and instance components (or instances), and unique components which are connected components that do not belong to any repetitive structures. Patterns are the representative geometry of repetitive structures. Instances are “pattern-instance” representation of the corresponding instance components. In one embodiment, a pattern is not selected as one of the components of the input model; rather it is aligned with the world coordinate system. For example, a pattern can be generated by selecting an instance component of the repetitive structure and moving it to the origin of the world coordinate, rotating it so that its eigenvectors are aligned to the world coordinate. The reason for such rotation is that, as shown in WO2010149492, compressing 3D models which have been aligned with the world coordinate system helps minimizing the visual artifacts caused by vertex position quantization because of the small quantization error. This is particularly beneficial for large flat surfaces. In a different embodiment of generating a pattern, only shifting of a selected instance component to the origin is done, and no rotation is performed. In this case, the selected instance component would have the least transformation to the pattern, i.e. no rotation in its transformation matrix. Typically, the number of bits allocated to the compressed rotation sub-matrix/part is high. Thus, in this embodiment, there are no bits assigned to the rotation sub-matrix/part for the selected instance component, which reduces the encoded bit rate. In a different embodiment, instance components of repetitive structures are clustered and the instance component which is close to the center of the cluster is picked to generate the pattern. This embodiment leads to small values of the rotation information for most of the instance components in the cluster and thus fewer bits for the rotation information in the compressed bitstream.

The instances can be represented by
A repetitive structure ID or a pattern ID.
An instance transformation matrix Inst_Transf as mentioned in Eqn. (1) or Eqn. (7), which may include information on scaling, rotation and translation etc.

As can be seen from Eqn. (1), an instance component can be completely recovered from the instance transformation matrix Inst_Transf and the corresponding pattern, which can be retrieved using the pattern ID. Thus, when compressing an instance component, it is equivalent to compress the pattern ID and the instance transformation matrix. In this application, “instance” and “instance component” are used interchangeably to refer to the component or its instance representation since they are equivalent.

E.2) Determine Compression Mode (604)

In order to guarantee that the compression ratio is not decreased by introducing repetitive structure discovery into the codec, a decision needs to be made between the compression mode for the 3D model using the “pattern-instance” representation (RS encoding mode) or the original representation (unique mode) after repetitive structures discovery/identification. The general guidelines are:
If one instance component contains a small number of vertices, it should be treated as unique components rather than instances as the instance representation may cost more bits than the original geometry representation.
If there are a small number of instance components, the geometry representation of the entire input 3D model should be chosen for compression in the unique mode.

The first step is to decide whether or not to compress scaling factors. To determine a scaling factor, according to one embodiment, all the instance components of a repetitive structure are shifted to their corresponding mean and rotated to the world coordinate. A bounding box ([xₘᵢₙ, xₘₐₓ], [yₘᵢₙ, yₘₐₓ], [zₘᵢₙ, zₘₐₓ]) is calculated for each shifted and rotated instance component, where xₘᵢₙ, xₘₐₓ, yₘᵢₙ, yₘₐₓ, zₘᵢₙ, zₘₐₓ are the minimum and maximum of the coordinate of the instance components along x, y, z axis, respectively. In one embodiment, the instance component with the largest bounding box is picked to generate the pattern. For the remaining instance components, the bounding box of each instance component is compared with that of the pattern to determine the scaling factor. The reason of using the instance component with the largest bounding box as the pattern is to make all the scaling factors smaller than or equal to 1. This helps preserving the precision after recovering the component. When the scaling factor is smaller than 1, the recovered instance component is the shrunk version of the pattern, whose higher digits of the coordinate of the vertices are relatively accurate after decoding and thus the recovered component is relatively accurate. On the other hand, if the scaling factor is larger than 1, the recovered instance component is the magnified version of the pattern, whose lower digits of the coordinates of the vertices, which are usually not accurate after decoding, are magnified. Thus the recovered instance component may contain large decoding error. Since a scaling factor affects every entry in a transformation matrix, it will be compressed without loss in a preferred embodiment if it is determined to be compressed. Thus, the compressed scaling factors will cost more bits than other types of instance information. Compressing scaling factors may decrease the entire compression ratio if there are only a small number of scaling factors not equal to 1, which means there are not many scaling factors need to be compressed and the overhead of compressing them exceeds the bit savings by the compression. Thus the decision can be made as follows
If the instance components with scaling factors equal to 1.0 contain more than a predetermined ratio, e.g. 70%, of the total vertices of all instance components, the scaling factors will not be compressed.

If it is determined not to compress the scaling factors, the instance components whose scaling factor is not equal to 1 will not be treated as the instance components of the repetitive structure. Attempts to regroup these components as repetitive structure with scaling factor 1 will be made. After these steps, the components that do not belong to any repetitive structures are regarded as unique components. For example, a repetitive structure contains 10 large book components and 4 small book components. The scaling factors for the 10 large book components are 1 and that for the 4 small book components are 0.75 for 3 of them and 0.5 for one of them. If it is determined that the scaling factors will not be compressed, the 10 large book components may still be treated as instance components of the original repetitive structure and compressed in the “pattern-instance” representation. Three of the small book components with original scaling factor 0.75 will form a new repetitive structure with scaling factor 1 and the remaining one small book component whose original scaling factor was 0.5 will be treated as a unique component since it does not belong to any repetitive structure.

The final decision of whether to compress the 3D model in the repetitive structure representation, i.e. in the RS encoding mode, is made by the following steps.
1. Check all remaining instance components after the above filtering process. If the vertex number of an instance component is less than some predetermined value, e.g. 5, it is regarded as a unique component.
2. If the remaining instance components include less than a predetermined ratio, e.g. 50%, of the input vertices, the geometry representation of the entire input 3D model is compressed without the RS encoding mode.

E.3) Encode Patterns (608)

There are two options to encode the patterns: separate encoding and group encoding. Compared with group encoding, i.e. encoding all patterns together, encoding patterns separately may cost more bits because of the followings reasons.
Byte alignment when finishing compressing a single pattern. The byte alignment issue is caused by the entropy coding, such as the arithmetic entropy coding, wherein if one byte is not filled up by the compressed bits, it is padded to a full byte. For each encoded pattern, this byte alignment needs to be done and it would increase the bit rate.
Probability model initialization when starting compressing a single pattern. For entropy coding, such as the arithmetic coding, a probability model of the data is initialized to predict the distribution of the data to be encoded. When separately encoding each pattern, such a probability model needs to be estimated for each pattern, which incurs high overhead.
   Thus a preferred embodiment encodes all patterns as one “pattern” model using a traditional 3D mesh codec specified by the user, such as the SC3DMC codec described in final text of ISO/IEC 14496-16 4th Edition, MPEG-3DGC, 93th MPEG meeting, Section 5.2.5, Annex M-Annex P. For the same reason, all unique components are compressed together in a preferred embodiment.

As the instance component verification step requires the decoded patterns and the order of the patterns might be changed in the decoded “pattern” model, after decoding the “pattern” model, the components of the decoded “pattern” model need to be recognized to calculate the new IDs (610) of patterns in the component sequence of the decoded “pattern” model so that they match the original pattern IDs.

E.4) Update Instance Transformation (610)

The instance transformation calculated during repetitive structure discovery is not accurate as it does not consider the decoding error of patterns. With the decoded patterns, the instance transformation can be updated for a better accuracy as follows

Inst_Comp=Inst_Transf×Decoded_Pattern. (4)

E.5) Verify Instances (628)

In order to control the decoding error, the encoder calculates the decoding error of instance components and those with decoding error larger than the user specified threshold do not pass the instance verification. In one embodiment, the decoding error is calculated as the surface distance between the decoded instance component and the original instance component:

Decoding_Err=Surface_dist(Decoded_Inst_Comp,Ori_Inst_Comp) (5)

where,

Decoded_Inst_Comp=Decoded_Inst_Transf×Decoded_Pattern. (6)

An example method for calculating the surface distance between two components can be found in N. Aspert, D. Santa-Cruz and T. Ebrahimi, MESH: Measuring Error between Surfaces using the Hausdorff distance, in Proceedings of the IEEE International Conference on Multimedia and Expo 2002 (ICME), vol. I, pp. 705-70.

The compressed transformation of those instances passing the instance verification is output to the compressed bitstream according to the data packing mode selected by the user as will be explained later. The instance components fail to get through the instance verification will be treated as unique components and compressed together with other unique components.

E.6) Recognize Patterns (610)

As all patterns are compressed together in PB3DMC, the pattern decoder needs to recognize the patterns by separating the decoded “pattern” model into connected components and recover their orders that match the encoding order of the patterns.

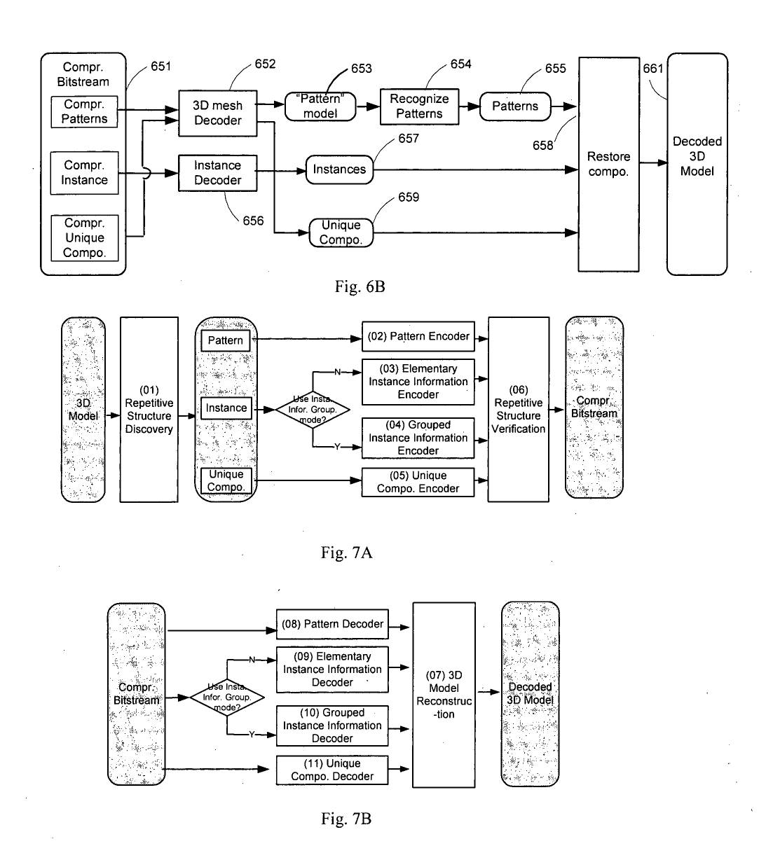

FIG. 6 shows the block diagram of the PB3DMC codec. In this figure, rectangles with sharp corners represent the blocks within the codec that perform certain operations; rectangles with rounded corner represent data that are input to or generated/output by the blocks in the codec. FIG. 6A shows the encoder and FIG. 6B shows the decoder. The input of the encoder is a 3D mesh model 601 to be compressed. The model is first input into a repetitive structure discovering unit 602 to identify the repetitive structures in the 3D model. The identified results are feed into a determination unit 604 to determine if the 3D model should be compressed using the “pattern-instance” representation, i.e. in a RS encoding mode. If not, the 3D model is fed into a 3D mesh encoder 606 for compression to output a compressed bitstream 603 for the 3D model. If there are components in the 3D model that are determined to be compressed using the “pattern-instance” representation, the determination unit 604 will pass the 3D model in terms of “pattern-instance” representation 605 to the next step. The representation 605 contains the patterns for the repetitive structures and the corresponding instance components as well as the unique components. In this embodiment, the patterns and the unique components of 605 are sent to a 3D mesh encoder 608, which can be the same encoder as the mesh encoder 606. In a preferred embodiment, all the patterns are encoded together. In a different embodiment, each of the patterns is encoded separately. Compared with separately encoding each pattern, encoding them altogether has the advantage of low overhead. The compressed patterns 607 are incorporated into the compressed bitstream 603. Similarly, the unique components are also compressed by the 3D mesh encoder 608 and preferably compressed together to generate compressed unique components 609, which are then incorporated into the compressed bitstream 603.

For the instance components of 605, instance transformation with respect to the corresponding pattern and the pattern ID are calculated, or recalculated if it has been calculated during the repetitive structure discovery, in the calculation unit 610. In order to reduce decoding error for the instance component, a decoded pattern 611 instead of the original pattern is used for the instance transformation calculation. The decoded pattern 611 is generated by a 3D mesh decoder 612 decoding the compressed pattern 607. The output of the calculation unit 610 is the instance information 613, which contains the pattern ID and the transformation matrix. The pattern ID needs to be calculated/registered when all the patterns are encoded together as disclosed above in a preferred embodiment of the 3D mesh encoder 608. During the encoding, all the pattern models are put on the same face and encoded using a mesh encoder as a normal 3D model. After the decoding by the 3D mesh decoder 612, the order of the patterns may be changed. In order to find the right pattern for the corresponding instance component, new pattern ID needs to be calculated to map the decoded pattern back to the original pattern. The transformation matrix in 613 can be decomposed into the reflection part, the rotation part, the translation part, and a possible scaling part. As mentioned before, PB3DMC directly compresses the transformation matrix. An example encoding scheme of the instance transformation matrix can be found in PCT application PCT/CN2011/082942, filed on Nov. 25, 2011, entitled Repetitive Structure Discovery based 3D Model Compression, the teachings of which are herein incorporated by reference in its entirety. According to one embodiment in PCT/CN2011/082942, the instance transformation matrix Inst_Transf is decomposed into four parts, a reflection part (Refle), a rotation part (Rotat1 or Rotat2), a translation part (Transl), and a possible scaling part, as shown below:

$$Inst\_Transf = [ \begin{matrix}[ Rotat\_Refle ] & [ Transl ] \\ 0 \; 0 \; 0 & 1\end{matrix} ] \times Scaling \qquad ( 7 )$$

where, Rotat_Refle can be decomposed into

Rotat_Refle=Refle×[Rotat1]

or

Rotat_Refle=[Rotat2]×Refle.

The reflection part Refle can take the following value:

$$Refle = \{ \begin{matrix}[ \begin{matrix}1 & 0 & 0 \\ 0 & 1 & 0 \\ 0 & 0 & - 1\end{matrix} ] , & if there is reflection transformation \\ [ \begin{matrix}1 & 0 & 0 \\ 1 & 0 & 1 \\ 0 & 0 & 1\end{matrix} ] , & otherwise .\end{matrix} \qquad ( 8 )$$

In a different implementation, Refle can also take the values of

$$[ \begin{matrix}1 & 0 & 0 \\ 0 & - 1 & 0 \\ 0 & 0 & 1\end{matrix} ] or [ \begin{matrix}- 1 & 0 & 0 \\ 0 & 1 & 0 \\ 0 & 0 & 1\end{matrix} ]$$

if there is reflection transformation.

In this embodiment, the reflection part can be represented and compressed by a 1-bit flag. The rotation part (Rotat1 or Rotat2) is a 3×3 matrix and compressed by three Euler angles (alpha, beta, gamma), which is first quantized and then compressed by some entropy codec. The translation part (Transl) is a 3 dimensional column vector, which is first quantized and then compressed by some entropy codec (elementary mode) or an octree-based (OT) encoder 614 (group mode), as will be disclosed later. The scaling part is represented by a uniform scaling factor of the instance and compressed by the lossless compression algorithm for floating point numbers.

It is apparent that in PB3DMC, the compression schemes of these sub-matrices/parts are different, and they also depend on an instance data packing mode specified by the user. Recall that each instance has two parts of data: Pattern ID and transformation matrix. There are two packing modes for the instance data: an elementary mode and a group mode. In the elementary mode, the entire instance data for the instance components are encoded sequentially, i.e. (PID 1, trans 1) (PID 2, trans 2), . . . , (PID n, trans n), wherein PID x and trans x are the pattern ID and transformation matrix for component x, respectively and x=1, . . . , n. In the group mode, PIDs for a group of instances are encoded together followed by the encoding of the transformation matrices for that group of instances, i.e. (PID 1, PID 2, . . . , PID n)(reflection 1, reflection 2, . . . , reflection n), (translation 1, translation 2, . . . translation n), (rotation 1, rotation 2, . . . , rotation n), (scaling 1, scaling 2, scaling n). The details of the instance data packing mode are disclosed in PCT application PCT/CN2011/076991, filed on Jul. 8, 2011, entitled “Bitstream Syntax for Repetitive Structures, with Position, Orientation and Scale Separate for Each Instance”, the teachings of which are herein incorporated by reference in its entirety.

In the PB3DMC codec, the instance translation part is encoded according to the data packing mode chosen by the user. If the group mode is selected, an octree-based (OT) encoder 614 as disclosed in m22771, 98^{th} MPEG meeting proposal, entitled “Bitstream specification for repetitive features detection in 3D mesh coding” is used to encode the instance translation part and to generate the compressed group instance translation information 615. It is to be noted that during the decoding, the OT decoder may change the order of the instance translation parts for different instances, which would cause mismatch between the instance translation parts with other parts, such as rotation parts, and pattern IDs, and lead to decoding errors. To solve the problem, the OT decoder can be run at the encoder side to find out how the order of the instance translation parts for different instances is changed so that the pattern ID and other instance component information can be encoded in the same order in the compressed bitstream for a correct decoding of the instance component at the decoder. In a different embodiment, the instance translation part indices in the original instance order are inputted to the OT encoder 614, along with instance translation information. With such information, the OT encoder 614 can output the new indices of each instance translation parts according to the octree traversal order, i.e. the decoded translation parts order. The advantage of this embodiment is that there is no need to run the OT decoder at the encoder side.

If the elementary data packing mode is selected, the instance translation part goes through an n-bit quantization unit 616 to generate the compressed instance translation information 617.

The instance rotation part is encoded by a rotation encoder 618 to generate the compressed instance rotation information 619. The instance scaling factor is compressed without loss by a floating point encoder 620 to generate the compressed instance scaling information 621. An example floating point encoder can be found in Martin Isenburg, Peter Lindstrom, Jack Snoeyink, Lossless Compression of Floating-Point Geometry, Proceedings of CAD'3D, May 2004. Since the scaling factor affects every entry of the transformation matrix, lossless compression of the scaling factor would reduce the decoding error.

The instance reflection part, which is a one-bit flag, will be sent directly to the compressed instance information packing unit 622 to combine with other information. It can be further compressed when possible. For example, if the group packing mode is selected and the instance reflection flags for the instance components are combined together as described earlier, a run-length encoding or other entropy coding can be applied to compress the reflection flags to further reduce bitrate.

In a preferred embodiment of the present invention, in order to obtain a low decoding error, the number of bits assigned to the instance rotation parts, instance translation parts and patterns in the compressed bit stream have the following relationship Bits_rotation≧Bits_translation≧Bits_pattern. For example, when quantizing the instance rotation parts, a higher number of bits, e.g. 14 bits, are assigned than that for the quantization of the translation parts, e.g. 13 bits, which is higher than the bits for quantizing the vertices of the patterns, e.g. 12 bits. Such a bit assignment can lead to a low decoding error, because an error in the rotation part can introduce a high decoding error especially for a component with large size after the rotation, and the translation and pattern error typically remain the same after the transformation.

With the compressed group instance translation information 615 (or the compressed instance translation information 617 depending on the data packing mode selected by the user), the compressed instance rotation information 619, the compressed instance scaling information 621, the instance reflection flag and the corresponding pattern ID, the instance information can be packed in the compressed instance information packing unit 622 to generate the compressed instance information 623. However, in a preferred embodiment, to control the decoding error, the compressed instance components are input into a verification process before sending to the packing unit 622.

The verification is performed by an instance component verification unit 628. The verification unit 628 takes the decoded patterns 611, decoded instance translation part 625, decoded instance rotation parts 627, the original instance reflection flag from 613 (since it is compressed without loss) and the original instance scaling of 613 (since it is compressed without loss) as input to calculate a decoding error and compare it with a user-specified threshold as described elsewhere in this application. To generate the decoded instance rotation part 627, an orientation decoder 626, which comprises an entropy decoder and a de-quantization unit, is applied onto the compressed instance rotation information 619. To generate the decoded instance translation part 625, an n-bit de-quantization unit 624 is applied onto the compressed instance translation information 617 regardless of the data packing mode. Note that it may not be necessary to employ the OT encoder and decoder for the verification purpose. Only the quantization within the OT encoder affects the decoding error and it can be modeled by the quantization of 616. The output of the verification unit 628 is the instance component verification results 629 which contain the verified instance index, for identifying the verified instance components, and discarded instance components. For those discarded instance components, they will not be compressed in the “pattern-instance” representation and will be treated as unique components and sent to the 3D mesh encoder 608 for encoding.

For those instance components that pass the verification, their compressed instance information including compressed group instance translation information 615 (or compressed instance translation information 617), compressed instance rotation information 619, compressed instance scaling information 621, the reflection flag and the corresponding pattern ID will be sent to the compressed instance information packing unit 622 to generate the compressed instance information 623 which is further incorporated into the compressed bitstream 603. Note that if the group mode is selected, after verification, the OT encoder 614 will be used to encode the translation parts of all instances that pass the verification and generate the compressed group instance translation information and instance order as the input of the compressed instance information packing unit 622. The compressed instance information packing unit 622 will reorder the other instance information according to the instance order generated by OT encoder 614.

If the elementary mode is selected, a different embodiment of the above process is to use a loop of encoding followed by verification for each instance. If one instance passes the verification, its encoded information can be directly outputted to the compressed information packing unit 622. The advantage of this embodiment is that no buffer is needed.

Due to the verification process, it is possible that none of the instance components of a certain pattern passes the verification, which makes encoding the pattern meaningless. Therefore, it is desirable to encode only patterns that have at least one instance component passing the verification. According to another embodiment of this invention, all patterns which have at least one related instance passes verification are encoded and then recognized to find out the correct order of the patterns, i.e. correct pattern ID. The compressed patterns are then output to the compressed stream 603 after finishing verifying all instances. The pattern ID of all instances passing verification will be re-set accordingly before outputting to the compressed stream.

The PB3DMC decoder as shown in FIG. 6B takes a compressed bitstream 651 as inputs which includes compressed patterns, compressed instance components and compressed unique components. The compressed patterns and unique components are decoded by a 3D mesh decoder 652 to generate pattern models 653 and unique components 659. Further, a pattern recognizing unit 654 is applied on the pattern model 653 to identify the patterns 655. An instance decoder 656 is employed to obtain the decoded instance 657 which is then sent to a component restoring unit 658 along with the patterns 655 and unique components 659 to generate the final decoded 3D model 661.

FIG. 7A and FIG. 7B shows the high-level block diagram for the PB3DMC encoder and PB3DMC decoder, respectively. During encoding, a 3D model first goes through the repetitive structure discovery process, which output the 3D model in terms of patterns, instances and unique components. A pattern encoder is employed to compress the patterns and a unique component encoder is employed for encoding the unique components. For the instances, the instance component information is encoded based on a user-selected mode. If instance information group mode is selected, the instance information is encoded using grouped instance information encoder; otherwise, it is encoded using an elementary instance information encoder. The encoded components are further verified in the repetitive structure verification stage before being sent to the compressed bitstream. During the decoding, the patterns in the compressed bitstream of the 3D model are decoded by a pattern decoder and the unique components are decoded by a unique component decoder. The decoding of the instance information also depends on the user-selected mode. If instance information group mode is selected, the instance information is decoded using a grouped instance information decoder; otherwise, it is decoded using an elementary instance information decoder. The decoded patterns, instance information and unique components are reconstructed to generate the output decoded 3D model.

Although preferred embodiments of the present invention have been described in detail herein, it is to be understood that this invention is not limited to these embodiments, and that other modifications and variations may be effected by one skilled in the art without departing from the scope of the invention as defined by the appended claims.

1. A method for encoding a 3D model, comprising:
identifying a repetitive structure in said 3D model;
encoding said repetitive structure in a repetitive structure encoding mode; and
verifying each encoded instance component of said encoded repetitive structure.

2. The method of claim 1, further comprising
if said encoded instance component passes the verification, outputting said encoded instance component into a compressed bitstream for said 3D model; and
if said encoded instance component does not pass the verification, re-encoding said instance component in a different mode.

3. The method of claim 2, wherein said re-encoding step encodes said instance component that does not pass the verification in a unique encoding mode.

4. The method of claim 3, wherein the unique encoding mode employs a mesh encoder.

5. The method of claim 1, wherein said identifying step comprises generating a pattern for said repetitive structure and said encoding repetitive structure in a repetitive structure encoding mode comprises:
encoding said pattern for said repetitive structure;
decoding the encoded pattern; and
encoding each instance component of said repetitive structure by encoding instance component information generated by comparing said each instance component with said decoded pattern.

6. The method of claim 5, wherein said instance component information comprises an identification to said pattern and a transformation between said instance component and said decoded pattern.

7. The method of claim 6, wherein said transformation comprises a transformation matrix and encoding said transformation is performed by encoding each entry of said transformation matrix.

8. The method of claim 7, wherein said transformation matrix comprises a rotation part, a translation part and a reflection part; and wherein a number of encoding bits assigned to said rotation part is no smaller than a number of encoding bits assigned to said translation part, which is no smaller than a number of encoding bits assigned to said pattern.

9. The method of claim 5, wherein the pattern is encoded using a mesh encoder.

10. The method of claim 5, wherein said identifying step is performed multiple times to identify multiple repetitive structures, and wherein patterns for said multiple repetitive structures are encoded together.

11. The method of claim 5, wherein said decoding the encoded patterns further comprises recognizing said decoded patterns.

12. The method of claim 1, further comprising determining if compressing the 3D model in a unique encoding mode.

13. The method of claim 12, wherein said determining step determines to encode said 3D model in the unique encoding mode when said 3D model has a smaller number of instance components than a predetermined threshold.

14. The method of claim 1, wherein said verifying step comprises
decoding said encoded instance components;
calculating a decoding error for said decoded instance component by comparing said decoded instance component with a corresponding instance component; and
determining if said encoded instance component passes the verification based on the calculated decoding error.

15. The method of claim 14, wherein said determining step determines that said encoded component passes the verifying step if said decoding error is lower than a user specified threshold; and that said encoded component does not pass the verifying step if said decoding error is higher than the user specified threshold.

16. A method for decoding a compressed 3D model, comprising:
decoding patterns from a bitstream of said compressed 3D model;
decoding instance component information from said bitstream; and
restoring instance components using said decoded patterns and said decoded instance component information.

17. The method of claim 16, further comprising
decoding and restoring unique components from said bitstream; and
generating said decoded 3D model by incorporating said decoded instance components and said decoded unique components.

18. A 3D model encoder, comprising:
a repetitive structure identification unit for identifying a repetitive structure in said 3D model;
a repetitive structure encoder for encoding said repetitive structure in a repetitive structure encoding mode; and
an instance component verification unit for verifying each encoded instance component of said encoded repetitive structure.

19. The encoder of claim 18, wherein
if said instance component verification unit decides that said encoded instance component passes the verification, said instance component verification unit outputs said encoded instance component into a compressed bitstream for said 3D model; and
if said instance component verification unit decides that said encoded instance component fails the verification, said instance component verification unit outputs said encoded instance component to a different encoder for re-encoding.

20. The encoder of claim 19, further comprising:
a unique mode encoder for re-encoding said instance components that fail the verification in a unique encoding mode.

21. The encoder of claim 20, wherein the unique mode encoder comprises a mesh encoder.

22. The encoder of claim 18, wherein said repetitive structure identification unit generates a pattern for said repetitive structure and said repetitive structure encoder comprises:
a pattern encoder for encoding the generated pattern for said repetitive structure;
a pattern decoder for decoding the encoded pattern; and
a component information encoder for encoding each instance component of said repetitive structure by encoding instance component information generated by comparing said each instance component with said decoded pattern.

23. The encoder of claim 22, wherein the pattern encoder comprises a mesh encoder.

24. The encoder of claim 22, wherein said repetitive structure identification unit is run multiple times to identify multiple repetitive structures, and wherein said pattern encoder encodes patterns for said multiple repetitive structures altogether.

25. The encoder of claim 22, wherein said pattern decoder further comprises a pattern recognizer for recognizing said decoded patterns.

26. The encoder of claim 18, wherein said instance component verification unit comprises:
an instance component decoder for decoding said encoded instance components;
an error calculation unit for calculating a decoding error for said decoded instance component by comparing said decoded instance component with a corresponding instance component; and
a determination unit for determining if said encoded instance component passes verification based on the calculated decoding error.

27. The encoder of claim 26, wherein said determination unit determines said encoded component as passing the verification if said decoding error is lower than a user specified threshold, and as failing the verification if said decoding error is higher than the user specified threshold.

28. The encoder of claim 18, further comprising a compression mode determining unit for determining if compressing the 3D model in a unique encoding mode.

29. The encoder of claim 28, wherein said determining unit determines to encode said 3D model in the unique encoding mode when said 3D model has a smaller number of instance components than a predetermined threshold.

30. A 3D model decoder, comprising:
a pattern decoder for decoding patterns from a bitstream of a compressed 3D model;
an instance component information decoder for decoding instance component information from said bitstream; and
a component restoring unit for restoring instance components using said decoded patterns and said decoded instance component information.

31. The 3D model decoder of claim 30, further comprising
a unique component decoder for decoding unique components from said bitstream wherein said decoded unique components and said decoded instance components are incorporated to generate said decoded 3D model.
